(19) United States
(12) Patent Application Publication
(10) Pub. No.: US 2021/0312324 A1
(43) Pub. Date: Oct. 7, 2021

(54) SYSTEMS AND METHODS FOR INTEGRATION OF HUMAN FEEDBACK INTO MACHINE LEARNING BASED NETWORK MANAGEMENT TOOL

(71) Applicant: Cisco Technology, Inc., San Jose, CA (US)

(72) Inventors: Xinyuan Huang, San Jose, CA (US); Debojyoti Dutta, Santa Clara, CA (US); Elvira Dzhuraeva, San Jose, CA (US)

(21) Appl. No.: 16/842,334

(22) Filed: Apr. 7, 2020

(51) Int. Cl. G06N 20/00; G06K 9/62

(52) U.S. Cl. CPC G06N 20/00; G06K 9/6263

(57) ABSTRACT

The present disclosure is directed to system and methods for providing machine learning tools such as Kubeflow and other similar ML platforms with human-in-the-loop capabilities for optimizing the resulting machine models. In one aspect, a machine learning integration tool includes memory having computer-readable instructions stored therein and one or more processors configured to execute the computer-readable instructions to execute a workflow associated with a machine learning process; determine, during execution of the machine learning process, that non-automated feedback is required; generate a virtual input unit for receiving the non-automated feedback; modify raw data used for the machine learning process with the non-automated feedback to yield updated data; and complete the machine learning process using the updated data.

### TECHNICAL FIELD

The subject matter of this disclosure relates in general to the field of computer networking, and more particularly, to systems and methods for integrating human feedback into a machine learning and artificial intelligence based process for developing an automated network management tool.

### BACKGROUND

An Artificial Intelligence (AI) Center aims to provide a multi-cloud platform and management tools for simplifying development and deployment of machine learning (ML) workflows across a network. One of the tools AI Center intends to support is KubeFlow and other similar software (e.g., MLFlow, AirFlow, Pachyderm, etc.). These tools utilize a pipeline model that abstracts the machine learning workflow as one or more Directed Acyclic Graphs (DAGs). Each node can represent a self-contained set of user code that performs one step in the machine learning pipeline. For example, individual nodes can each be responsible for data pre-processing, data transformation, model training, and so on. When a user runs a pipeline, KubeFlow can launch compute instances (e.g., virtual machines, containers, etc.) to run the user code within each node

What is currently missing from KubeFlow and other similar tools is support for integration of human-in-the-loop that enables feedback from network operators, into such machine learning workflows (e.g., supervised learning, active learning).

### BRIEF DESCRIPTION OF THE FIGURES

To provide a more complete understanding of the present disclosure and features and advantages thereof, reference is made to the following description, taken in conjunction with the accompanying drawings, in which:

FIGS. 1A-C illustrates a network architecture, according to an aspect of the present disclosure;

FIG. 2 illustrates an example Directed Acyclic Graph for abstracting a machine learning pipeline, according to an aspect of the present disclosure;

FIG. 3 illustrates a high level architecture of a machine learning workflow, according to an aspect of the present disclosure;

FIG. 4 illustrates a machine learning workflow with integrated Human-in-the-Loop feature, according to an aspect of the present disclosure;

FIG. 5 describes a ML workflow process with integrated with integrated Human-in-the-Loop feature, according to an aspect of the present disclosure; and

FIGS. 6A-B illustrate examples of systems, according to an aspect of the present disclosure.

### DESCRIPTION OF EXAMPLE EMBODIMENTS

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

As noted above, human-in-the-loop is currently not supported by Machine Learning (ML) platforms such as Kubeflow, etc. Human-in-the-loop ML is an approach requiring human interaction (non-automated feedback) in the optimization loop of the ML model training or retraining. ML algorithms help to make predictions, categorize data, etc., but often they tend to be inaccurate, and therefore the results of the ML process are not as accurate as desired. Human input in model training and other stages of the ML workflow lifecycle can help accelerate the speed of learning, improve accuracy, and avoid bias, among other advantages.

The present disclosure is directed to system and methods for providing tools such as Kubeflow and other similar ML platforms with the human-in-the-loop capabilities for optimizing the resulting ML models used within a network Artificial Intelligence (AI) center for managing operations of complex network environments such as containerized environments (e.g., Kubernetes clusters).

In one aspect, a machine learning integration tool includes memory having computer-readable instructions stored therein and one or more processors configured to execute the computer-readable instructions to execute a workflow associated with a machine learning process; determine, during execution of the machine learning process, that non-automated feedback is required; generate a virtual input unit for receiving the non-automated feedback; modify raw data used for the machine learning process with the non-automated feedback to yield updated data; and complete the machine learning process using the updated data.

In another aspect, the one or more processors are configured to determine that the non-automated feedback is required when an output of the machine learning process does not meet a threshold.

In another aspect, the threshold is one of an accuracy threshold and a confidence threshold.

In another aspect, the virtual input unit is one a text message, an electronic mail message or an online advertisement.

In another aspect, the one or more processors are configured to determine that the non-automated feedback is required during one or more of a training data generation phase of the machine learning process, a model tuning phase of the machine learning process, and a model validation phase of the machine learning process.

In another aspect, the one or more processors are configured to execute the computer-readable instructions to transform the non-automated feedback by pre-processing and validating the non-automated feedback.

In another aspect, the one or more processors are configured to execute the computer-readable instructions to analyze effectiveness of the non-automated feedback based on metadata collected in association with the non-automated feedback.

In one aspect, one or more non-transitory computer-readable media include computer-readable instructions, which when executed by one or more processors of a machine learning orchestration system, cause the machine learning orchestration system to execute a workflow associated with a machine learning process; determine, during execution of the machine learning process, that non-automated feedback is required; generate a virtual input unit for receiving the non-automated feedback; modify raw data used for the machine learning process with the non-automated feedback to yield updated data; and complete the machine learning process using the updated data.

In one aspect, a machine learning method includes executing a workflow associated with a machine learning process; determining, during execution of the machine learning process, that non-automated feedback is required; generating a virtual input unit for receiving the non-automated feedback; modifying raw data used for the machine learning process with the non-automated feedback to yield updated data; and completing the machine learning process using the updated data.

### DETAILED DESCRIPTION

The disclosure begins an overview of a network architecture to which the present ML platforms with human-in-the-loop (HITL) capabilities of the present disclosure may be applied.

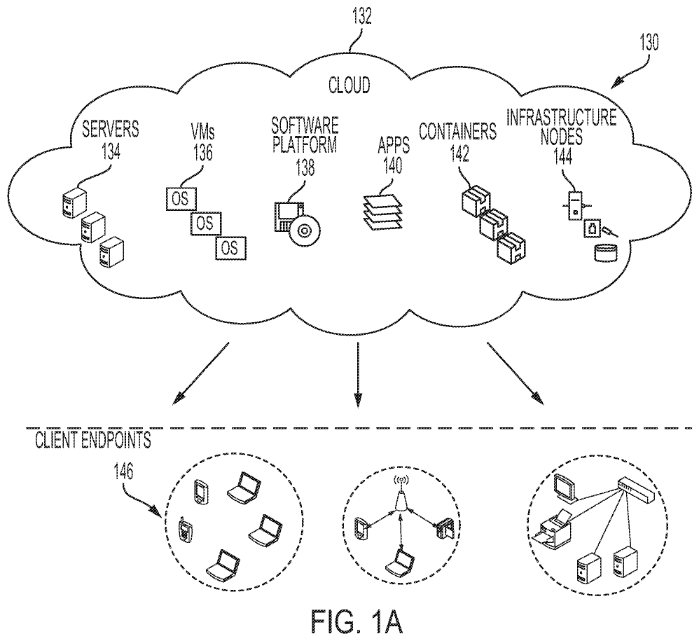

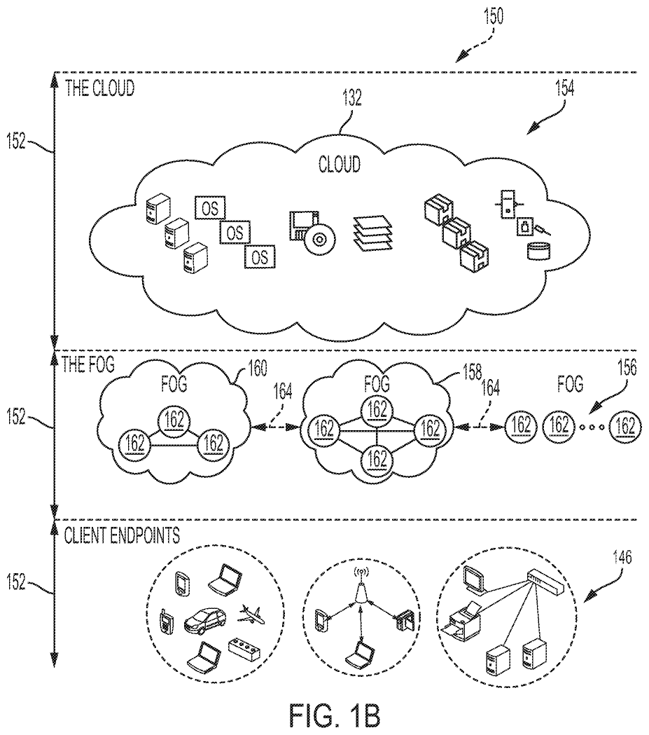

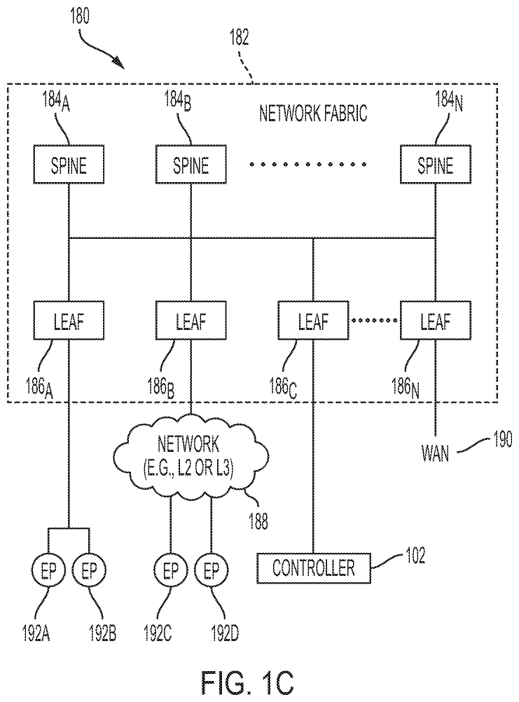

FIGS. 1A-C illustrates a network architecture, according to an aspect of the present disclosure.

FIG. 1A illustrates a diagram of an example cloud computing architecture (network) 130. The architecture can include a cloud 132. The cloud 132 can include one or more private clouds, public clouds, and/or hybrid clouds. Moreover, the cloud 132 can include cloud elements 134-144. The cloud elements 134-144 can include, for example, servers 134, virtual machines (VMs) 136, one or more software platforms 138, applications or services 140, software containers 142, and infrastructure nodes 144. The infrastructure nodes 144 can include various types of nodes, such as compute nodes, storage nodes, network nodes, management systems, etc. In one example, one or more servers 134 can implement the functionalities of a network controller 102, which will be described below and is illustrated in FIG. 1C. Alternatively, controller 102 can be a separate component that communicates with components of the cloud computing architecture 130 that function as a distributed streaming system similar to the distributed streaming system 120.

The cloud 132 can provide various cloud computing services via the cloud elements 134-144, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), function as a service (FaaS), and other types of services such as desktop as a service (DaaS), information technology management as a service (ITaaS), managed software as a service (MSaaS), mobile backend as a service (MBaaS), etc.

The client endpoints 146 can connect with the cloud 132 to obtain one or more specific services from the cloud 132. The client endpoints 146 can communicate with elements 134-144 via one or more public networks (e.g., Internet), private networks, and/or hybrid networks (e.g., virtual private network). The client endpoints 146 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture (network) 150. The fog computing architecture 150 can include the cloud layer 154, which includes the cloud 132 and any other cloud system or environment, the fog layer 156, which includes fog nodes 162 and client endpoints 146. The client endpoints 146 can communicate with the cloud layer 154 and/or the fog layer 156. The architecture 150 can include one or more communication links 152 between the cloud layer 154, the fog layer 156, and the client endpoints 146. Communications can flow up to the cloud layer 154 and/or down to the client endpoints 146.

In one example, one or more servers 134 can implement the functionalities of controller 102, which will be described below. Alternatively, controller 102 can be a separate component that communicates with components of the fog computing architecture 150 that function as a distributed streaming system similar to the distributed streaming system 120.

The fog layer 156 or “the fog” provides the computation, storage and networking capabilities of traditional cloud networks, but closer to the endpoints. The fog can thus extend the cloud 132 to be closer to the client endpoints 146. The fog nodes 162 can be the physical implementation of fog networks. Moreover, the fog nodes 162 can provide local or regional services and/or connectivity to the client endpoints 146. As a result, traffic and/or data can be offloaded from the cloud 132 to the fog layer 156 (e.g., via fog nodes 162). The fog layer 156 can thus provide faster services and/or connectivity to the client endpoints 146, with lower latency, as well as other advantages such as security benefits from keeping the data inside the local or regional network(s).

The fog nodes 162 can include any networked computing devices, such as servers, switches, routers, controllers, cameras, access points, kiosks, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. The fog instances 158 and 160 can be local or regional clouds or networks. For example, the fog instances 158 and 160 can be a regional cloud or data center, a local area network, a network of fog nodes 162, etc. In some configurations, one or more fog nodes 162 can be deployed within a network, or as standalone or individual nodes, for example. Moreover, one or more of the fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographic locations, logical locations or networks, and/or fog instances while maintaining connectivity with the cloud layer 154 and/or the endpoints 146. For example, a particular fog node can be placed in a vehicle, such as an aircraft or train, which can travel from one geographic location and/or logical location to a different geographic location and/or logical location. In this example, the particular fog node may connect to a particular physical and/or logical connection point with the cloud layer 154 while located at the starting location and switch to a different physical and/or logical connection point with the cloud layer 154 while located at the destination location. The particular fog node can thus move within particular clouds and/or fog instances and, therefore, serve endpoints from different locations at different times.

FIG. 1C illustrates a schematic block diagram of an example network architecture (network) 180. In some cases, the architecture 180 can include a data center, which can support and/or host the cloud 132. Moreover, the architecture 180 includes a network fabric 182 with spines 184A, 184B, . . . , 184N (collectively “spines 184”) connected to leafs 186A, 186B, 186C, . . . , 186N (collectively “leafs 186”) in the network fabric 182. Spines 184 and leafs 186 can be Layer 2 and/or Layer 3 devices, such as switches or routers. For the sake of clarity, they will be referenced herein as spine switches 184 and leaf switches 186.

Spine switches 184 connect to leaf switches 186 in the fabric 182. Leaf switches 186 can include access ports (or non-fabric ports) and fabric ports. Fabric ports can provide uplinks to the spine switches 184, while access ports can provide connectivity for devices, hosts, endpoints, VMs, or external networks to the fabric 182.

Leaf switches 186 can reside at the boundary between the fabric 182 and the tenant or customer space. The leaf switches 186 can route and/or bridge the tenant packets and apply network policies. In some cases, a leaf switch can perform one or more additional functions, such as implementing a mapping cache, sending packets to the proxy function when there is a miss in the cache, encapsulate packets, enforce ingress or egress policies, etc.

Moreover, the leaf switches 186 can contain virtual switching and/or tunneling functionalities, such as a virtual tunnel endpoint (VTEP) function. Thus, leaf switches 186 can connect the fabric 182 to an overlay (e.g., VXLAN network).

Network connectivity in the fabric 182 can flow through the leaf switches 186. The leaf switches 186 can provide servers, resources, endpoints, external networks, containers, or VMs access to the fabric 182, and can connect the leaf switches 186 to each other. The leaf switches 186 can connect applications and/or endpoint groups (“EPGs”) to other resources inside or outside of the fabric 182 as well as any external networks.

Endpoints 192A-D (collectively “endpoints 192”) can connect to the fabric 182 via leaf switches 186. For example, endpoints 192A and 192B can connect directly to leaf switch 186A, which can connect endpoints 192A and 192B to the fabric 182 and/or any other of the leaf switches 186. Similarly, controller 102 can connect directly to leaf switch 186C, which can connect controller 102 to the fabric 182 and/or any other of the leaf switches 186. On the other hand, endpoints 192C and 192D can connect to leaf switch 186A and 186B via network 188. Moreover, the wide area network (WAN) 190 can connect to the leaf switches 186N.

Endpoints 192 can include any communication device or resource, such as a computer, a server, a cluster, a switch, a container, a VM, a virtual application, etc. In some cases, the endpoints 192 can include a server or switch configured with a virtual tunnel endpoint functionality which connects an overlay network with the fabric 182. For example, in some cases, the endpoints 192 can represent hosts (e.g., servers) with virtual tunnel endpoint capabilities, and running virtual environments (e.g., hypervisor, virtual machine(s), containers, etc.). An overlay network associated with the endpoints 192 can host physical devices, such as servers; applications; EPGs; virtual segments; virtual workloads; etc. Likewise, endpoints 192 can also host virtual workloads and applications, which can connect with the fabric 182 or any other device or network, including an external network.

With examples of systems and network architectures described with reference to FIGS. 1A-C, the disclosure now turns to describing examples for providing machine learning tools such as Kubeflow and other similar ML platforms with the human-in-the-loop capabilities for optimizing the resulting ML models, which can ultimately be used for managing a network workflow (e.g., traffic management, load balancing, container spin up/off, etc.). Such machine-learning tools utilize a pipeline model that abstracts the machine learning workflow as one or more Directed Acyclic Graphs (DAGs).

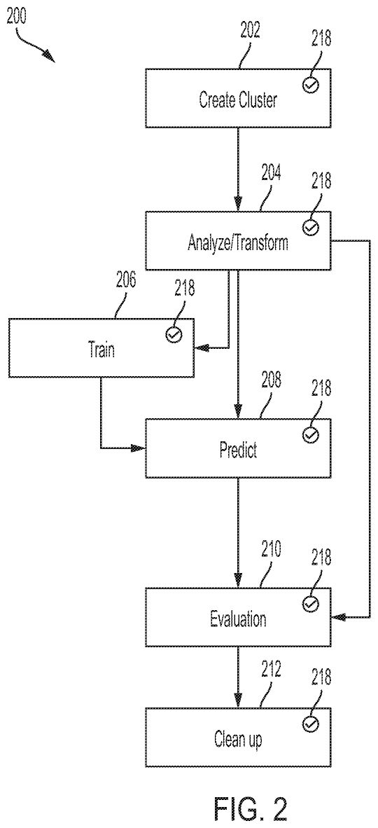

FIG. 2 illustrates an example Directed Acyclic Graph for abstracting a machine learning pipeline, according to an aspect of the present disclosure. Graph 200 of FIG. 2 is an example pictorial representation of the run-time execution of a machine-learning algorithm such as Kubeflow.

Graph 200 shows example steps/components 202, 204, 206, 208, 210 and 212 that the pipeline run has executed or is executing indicated by check mark 218 next to each executed or being executed step with arrows indicating parent/child relationships between any given number of components 202-212. For example, step 202 is considered a parent step relative to step 204 while step 206 is a child of step 204, etc.

The pipeline starts with step 202 in which a cluster of compute resource (e.g. VMs, containers, etc.) is created in the cloud. At step 204 data is analyzed for next steps by transforming raw data into training and evaluation data that can be consumed by the ML model. At step 206 preprocessed data are passed through ML model iteratively to train the model. After step 206, the trained model from step 206 and preprocessed evaluation data from step 204 are used in step 208 where the model performs inference with evaluation data as inputs, and generates prediction results as outputs. At step 210, the predictions are compared against “ground truth” information extracted from evaluation data so as to evaluate the accuracy of the trained model. Finally the pipeline reaches step 212 where all the tasks are finished and resources are cleaned up.

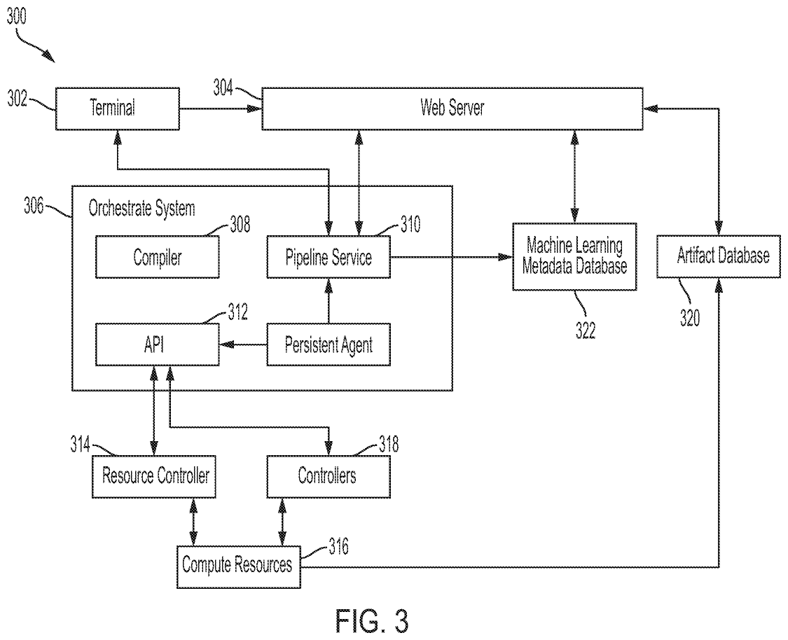

FIG. 3 illustrates a high level architecture of a machine learning workflow, according to an aspect of the present disclosure. Architecture 300 may be utilized to create, execute and manage a ML workflow (an ML workflow may be used synonymously with a pipeline, throughout the present disclosure). A ML workflow to be executed (e.g., Kubeflow example of graph 200 shown above) may be created using terminal 302, on which a graphical user interface (or alternatively using a Python Software Development Kit (SDK), a Command-Line Interface (CLI), etc.). Terminal 302 may be a laptop, a desktop, a handheld device, etc. Using such GUI/SDK?CLI, a user can define a ML workflow and its components.

Terminal 302 may be communicatively coupled to a web server 304 on which various information about ML workflows may be stored and accessed. Such information may include, but is not limited to, a ML workflow tasks created, task history, metadata of a given ML workflow, runtime and debugging information of a given ML workflow, visualization of artifacts, etc.

Terminal 302 may also be communicatively coupled to an orchestration system 306. A compiler 308 running on orchestration system 306 (e.g., a Kubeflow orchestration system) may then transform the pipeline's codes into a static configuration (e.g., YAML). A pipeline service 310 also running on orchestration system 306 (e.g., a Kubeflow orchestration system), can use an API service 312 (e.g., a Kubernetes API service) to communicate with a resource controller 316 (e.g., Kubernetes controller) for provisioning compute resources 316 such as virtual machines, container PODs, containers, etc., to run the pipeline. Various controllers 318 of the orchestration system 306 (e.g., task driven workflow controller(s), scheduled workflow controller(s), data driven workflow controller(s), distributed job controller(s), HP tuning controller(s), serving controller(s), etc.) may then execute compute resources 316 needed to complete the pipeline execution.

As the ML workflow is being executed by such controllers 318, various metadata and artifacts may be collected and stored in artifact database 320 that is communicatively coupled to compute resources 316 and web server 304. Examples of metadata may be stored as a MySQL database containing information on experiments, jobs, runs, etc., as well as single scalar metrics, generally aggregated for sorting data, filtering, etc. artifacts may be stored as Minio on a cloud storage and may include information on pipeline packages, views, etc., Also large-scale metrics like time series that can be used for investigating an individual workflow run's performance, debugging, etc.

Architecture 300 also has machine learning metadata database 322 that stored above described metadata and is communicatively coupled to pipeline service 310 and web server 304.

A persistent agent 324 may also be defined and communicatively coupled to pipeline service 310 and API 312 to monitor the compute resources 316 created by the pipeline service 310 and persists the state of these resources in the ML's stored metadata in database 322 including information on set(s) of compute resources 316 that executed as well as their inputs and outputs such as input/output compute resource parameters or data artifact Uniform Resource Identifiers (URIs).

All data collected during execution of the workflow/pipeline (or alternatively chosen subsets and/or visual representations thereof) may be displayed on a GUI of terminal 302 for the network operator/user (in real-time and/or after completion of execution of the workflow) along with relevant views such as list of pipelines currently running, history of pipeline execution, list of data artifacts, debugging information of individual pipeline runs, execution status of individual pipeline runs, etc.

With a ML workflow architecture described above, an integration of a Human-In-The-Loop (HITL) into such workflow will be described next.

HILT can be integrated into a ML workflow during the training data generation phase of such workflow to label the input data for an ML/AI algorithm, the model tuning phase during which the HITL can provide input for hard cases (e.g., where the machine learner lacks confidence of an outcome or is overly confident about a wrong outcome), and the model validation phase to assess the accuracy and other performance indicators of the model. As HITL continues to fine-tune the machine learner's responses to the edge/outlier cases, the machine learner can become more accurate and more consistent. The machine learner may even begin to analyze its own performance, identify areas where it is not effective, and send that data for HITL intervention for further evaluation. HITL can be particularly critical where there may too steep of a cost for a machine error (e.g., medical diagnosis, self-driving vehicles, drone strikes, etc.), when there is a lack of training data, when the data to be found is rare (e.g., face recognition, risk of cancer, failure to cite/attribute in academic writing), etc.

What is currently lacking in state-of-the-art ML workflow platforms is how and when to incorporate HITL in a given ML workflow, and how to manage the data (source code, model, artifacts, training data set, etc.) that can change as a result of human input. Hereinafter examples of tools will be described that can automate the process of model training and integration of HITL into an ML workflow.

For example, an AI center (e.g., pipeline service 310) can provide a workflow for simplifying integration of HITL during the model training phase. For example, the workflow can automate requesting for human feedback when an outcome determined by a machine learner is below a threshold level of accuracy, confidence level, or other metric. The ML workflow can provide different channels for obtaining human feedback (e.g., email, SMS text, AWS Mechanical, Facebook advertisements, etc.). The workflow can automatically route low confidence predictions to human annotators for review and validation as a pipeline plugin.

In another example, an AI center (e.g., pipeline service 310) can automate retraining of a machine learning model based on various thresholds, such as after receiving a specified amount of human feedback, when human feedback indicates the machine learner's results are below certain thresholds (accuracy, recall, false positive rate, false negative rate, precision, etc.).

An AI center (e.g., pipeline service 310) can automate segregation of the training data set based on human feedback. For example, once a model is trained (e.g., satisfies one or more performance thresholds), the remainder of the training data set can be used for validation of the model, etc.

In another example, AI center (e.g., pipeline service 310) can automate continuous retraining (if necessary), such as by periodically requesting for human feedback and when the results of human feedback fall below certain performance thresholds, Cisco AI center can trigger retraining of the model.

To implement HITL and integrate the same into a ML workflow, new user interface features may be added to merge new data (input by human feedback) to existing ML workflow, to specify column names, file format, match data format depending on the chosen step (e.g., the UI can enable a user to specify pre-processing of the HITL data before it is merged) and diagrams with input and output data format may be added.

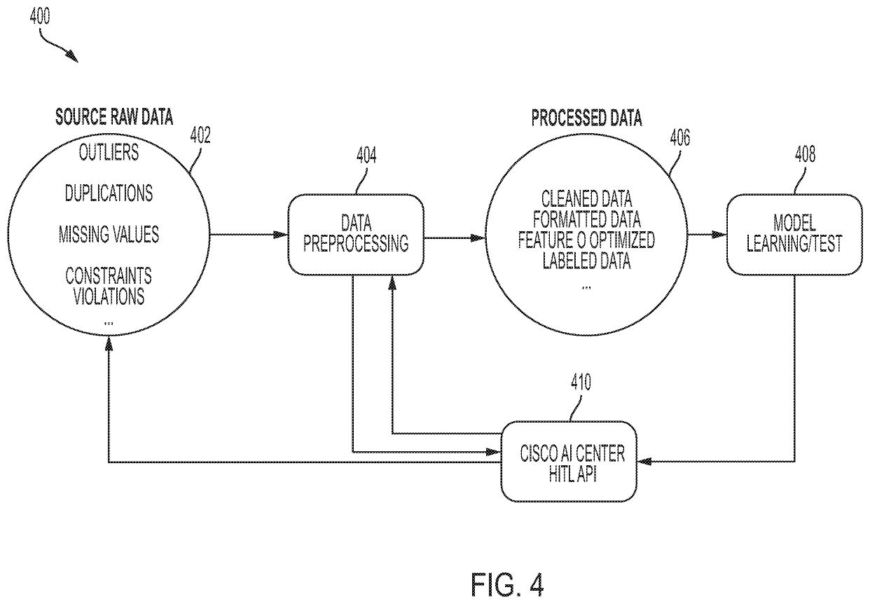

FIG. 4 illustrates a machine learning workflow with integrated Human-in-the-Loop feature, according to an aspect of the present disclosure. As can be seen from diagram 400, source raw data 402 may include data (for training and testing a ML workflow) that include duplicated data, outlier data, data/measurements with missing values, data collected/measured with constraint violations, etc. Source raw data 402 may be preprocessed at 404 to result in processed data 406 with outliers, duplicated data, etc. removed resulting in clean, formatted, optimized and/or labeled data. Such processed data 406 is then used for training/testing a ML workflow 408.

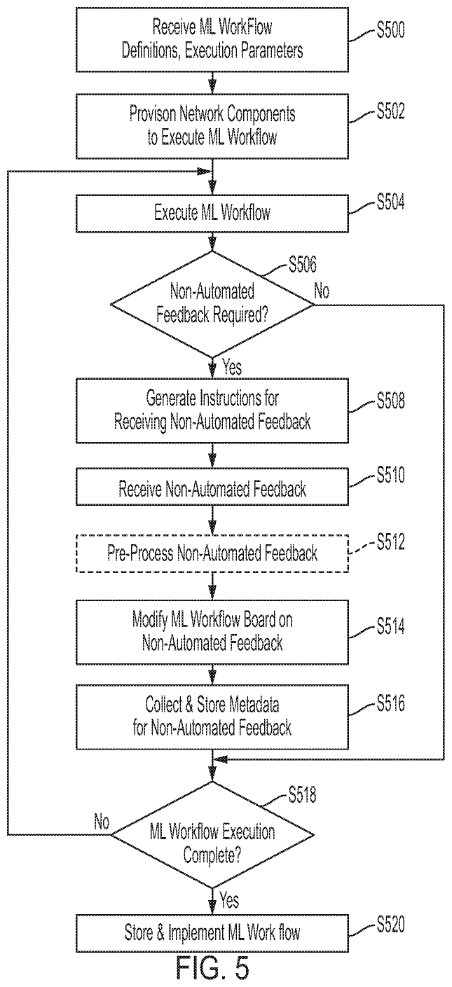

As can be seen from diagram 400, feedback from HITL 410 (provided via a user interface defined by an application programming interface (API)) may be injected and used at any one of the stages 402, 404 and 408. HITL may be used to specify API parameters to set up a mechanism of automated data formatting and labeling and/or for merging collected data with main data (e.g., Once enough data has been collected, the user needs to choose where his data should be merged to). This processed will be further described below with reference to FIG. 5.

FIG. 5 describes a ML workflow process with integrated with integrated Human-in-the-Loop feature, according to an aspect of the present disclosure. FIG. 5 will be described from the perspective of orchestration system 306 and more specifically pipeline service 310, which may be referred to as a ML workflow controller or AI center.

At S500, orchestration system 306 receives ML workflow definitions, execution parameters and components. An example workflow can be same as the one shown in FIG. 2. The definition of the workflow can be in a structured data format (e.g. json/yaml). The definition may contain at least, but not limited to, the following information: list of tasks, dependency relationships among tasks, the name of each task, The actions taken in each task (e.g. run a program to finish, or start a long-running service, etc.). It may also include information related to the infrastructure and platform where the workflow or workflow tasks are run. Below is an example definition (the definition below is merely an example and the format and parameters may differ and are not limited to what's showed):

name: example-workflow
spec:

tasks:
name: create-cluster
   action:
      command: create-cluster.sh
name: transform
   dependencies:
      create-cluster
   action:
      command: transform.sh
name: train
   dependencies:
      transform
   action:
      command: train.sh
name: predict
   dependencies:
      transform
      train
   action:
      command: predict.sh
name: evaluate
   dependencies:
      transform
      train
      predict
   action:
      command: evaluate.sh
name: cleanup
   dependencies:
      evaluate
   action:
      command: cleanup.sh

At S502, orchestration system 306 may provision network components for executing the ML workflow (e.g., via API 312 and resource controller 314 as described above with reference to FIG. 3).

At S504, orchestration system 306 executes the ML workflow defined at S500 using provisioned resources of S502. In one example, during execution at S504, a visual representation similar to graph 200 corresponding to already executed and currently executed steps of the ML workflow may be displayed on terminal 302. Such execution may corresponding to any one of training, testing and/or deployment of the defined ML workflow within a network.

At S506, orchestration system 306 determines if a non-automated feedback (e.g., human feedback via HITL input) is required for the ML workflow being executed at S504. In one example and as described above, such determined may be made if orchestration system 306 determines that an output (e.g., a prediction of a particular step, data processing criteria, etc.) of any step of the ML workflow does not meet a threshold, where such threshold may be a configurable parameter indicating a threshold level of accuracy, a confidence level, or other metrics.

If at S506, orchestration system 306 determines that non-automated feedback is not required, the process proceeds to S518, which will be further described below. However, if at S506, orchestration system 306 determines that the non-automated feedback is required, then at S508, orchestration system 306 generates instructions (e.g., a virtual input unit or a User Interface (UI)) for receiving the non-automated feedback. This virtual input unit enables the HITL feature to be integrated into the ML workflow. Such instructions and virtual input units can be any one or more of an electronic mail, a text message, an Amazon Web Services Mechanical, a social media post or advertisement, etc.).

At S510, orchestration system 306, receives non-automated feedback from a user via the virtual input unit or UI of S508.

At S512 (optionally), orchestration system 306 processes the non-automated feedback using a pre-processing and validation loop, where the data can be cleaned, formatted and validated using known or to be developed data pre-processing methods. S512 may be performed if, for example, initial data used for training/testing have been pre-processed also.

In another example, S512 may be skipped and raw non-automated feedback is merged with raw data used for the ML workflow (e.g., with raw data used for training and/or testing ML workflow)

At S514, orchestration system 306 modifies the ML workflow with on the raw or pre-processed non-automated feedback, where such modification can be merging of the non-automated data with training/testing data, validation of an output, modification of an output of the ML workflow, etc.

At S516, orchestration system 306 may collect and store (e.g., in machine learning metadata database 322) metadata associated with the non-automated feedback provided and used for the ML workflow, as described above. Such metadata can help illustrate impact of the non-automated feedback on data outputs, ML performance, etc., and be used to analyze effectiveness of the non-automated feedback on the ML workflow (alone or in combination with originally provided data).

Collected and stored metadata can include human provided inputs, including modifications to data in any stage of the ML workflow, modifications to the ML models, feedback from end-user, etc., operations that define the changes applied to the human provided inputs as well as original data/models, including processing, transformation, splitting of human provided inputs, and merging of human provided inputs into original data/models, new data after operations, including the references to the new data/models after the above operations, point of ingestion, the time/training step/etc. when the new data are ingested to the loop, and the location in the workflow where the new data are ingested.

At S518, orchestration system 306 determined if the execution of the ML workflow is complete (e.g., based on ML workflow definitions and parameters defined at S500). If completed, at S520, orchestration system 306 stored the completed ML workflow (e.g., trained and validated ML model) for implementation and utilization (e.g., for network operation management). If not complete, the process reverts back to S506 and S506 to S520 are repeated until the ML workflow is complete.

With the process and system of FIGS. 1-5 providing tools such as Kubeflow and other similar ML platforms with HITL capabilities for optimizing the resulting ML models used within a network for managing operations of complex network environments such as containerized environments (e.g., Kubernetes clusters), the disclosure now turns to example system configurations and components that can be utilized as controllers and components of the architecture of FIG. 3 for providing a HITL integrated ML workflow tool.

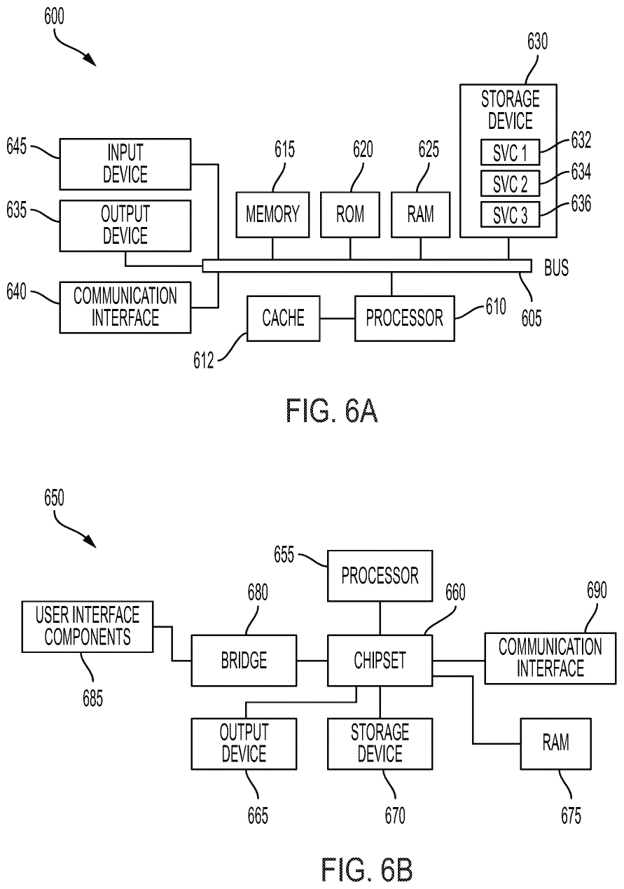

FIGS. 6A-B illustrate examples of systems, according to an aspect of the present disclosure.

FIG. 6A illustrates an example of a bus computing system 600 wherein the components of the system are in electrical communication with each other using a bus 605. The computing system 600 can include a processing unit (CPU or processor) 610 and a system bus 605 that may couple various system components including the system memory 615, such as read only memory (ROM) 620 and random access memory (RAM) 625, to the processor 610. The computing system 600 can include a cache 612 of high-speed memory connected directly with, in close proximity to, or integrated as part of the processor 610. The computing system 600 can copy data from the memory 615, ROM 620, RAM 625, and/or storage device 630 to the cache 612 for quick access by the processor 610. In this way, the cache 612 can provide a performance boost that avoids processor delays while waiting for data. These and other modules can control the processor 610 to perform various actions. Other system memory 615 may be available for use as well. The memory 615 can include multiple different types of memory with different performance characteristics. The processor 610 can include any general purpose processor and a hardware module or software module, such as SERVICE (SVC) 1 632, SERVICE (SVC) 2 634, and SERVICE (SVC) 3 636 stored in the storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing system 600, an input device 645 can represent any number of input mechanisms, such as a microphone for speech, a touch-protected screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing system 600. The communications interface 640 can govern and manage the user input and system output. There may be no restriction on operating on any particular hardware arrangement and therefore the basic features here may easily be substituted for improved hardware or firmware arrangements as they are developed.

The storage device 630 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof.

As discussed above, the storage device 630 can include the software services 632, 634, 636 for controlling the processor 610. Other hardware or software modules are contemplated. The storage device 630 can be connected to the system bus 605. In some embodiments, a hardware module that performs a particular function can include a software component stored in a computer-readable medium in connection with the necessary hardware components, such as the processor 610, bus 605, output device 635, and so forth, to carry out the function.

FIG. 6B illustrates an example architecture for a chipset computing system 650 that can be used in accordance with an embodiment. The computing system 650 can include a processor 655, representative of any number of physically and/or logically distinct resources capable of executing software, firmware, and hardware configured to perform identified computations. The processor 655 can communicate with a chipset 660 that can control input to and output from the processor 655. In this example, the chipset 660 can output information to an output device 665, such as a display, and can read and write information to storage device 670, which can include magnetic media, solid state media, and other suitable storage media. The chipset 660 can also read data from and write data to RAM 675. A bridge 680 for interfacing with a variety of user interface components 685 can be provided for interfacing with the chipset 660. The user interface components 685 can include a keyboard, a microphone, touch detection and processing circuitry, a pointing device, such as a mouse, and so on. Inputs to the computing system 650 can come from any of a variety of sources, machine generated and/or human generated.

The chipset 660 can also interface with one or more communication interfaces 690 that can have different physical interfaces. The communication interfaces 690 can include interfaces for wired and wireless LANs, for broadband wireless networks, as well as personal area networks. Some applications of the methods for generating, displaying, and using the technology disclosed herein can include receiving ordered datasets over the physical interface or be generated by the machine itself by the processor 655 analyzing data stored in the storage device 670 or the RAM 675. Further, the computing system 650 can receive inputs from a user via the user interface components 685 and execute appropriate functions, such as browsing functions by interpreting these inputs using the processor 655.

It will be appreciated that computing systems 600 and 650 can have more than one processor 610 and 655, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A machine learning integration tool, comprising:
memory having computer-readable instructions stored therein; and
one or more processors configured to execute the computer-readable instructions to:
execute a workflow associated with a machine learning process;
determine, during execution of the machine learning process, that non-automated feedback is required;
generate a virtual input unit for receiving the non-automated feedback;
modify raw data used for the machine learning process with the non-automated feedback to yield updated data; and
complete the machine learning process using the updated data.

2. The machine learning integration tool of claim 1, wherein the one or more processors are configured to determine that the non-automated feedback is required when an output of the machine learning process does not meet a threshold.

3. The machine learning integration tool of claim 2, wherein the threshold is one of an accuracy threshold and a confidence threshold.

4. The machine learning integration tool of claim 1, wherein the virtual input unit is one a text message, an electronic mail message or an online advertisement.

5. The machine learning integration tool of claim 1, wherein the one or more processors are configured to determine that the non-automated feedback is required during one or more of a training data generation phase of the machine learning process, a model tuning phase of the machine learning process, and a model validation phase of the machine learning process.

6. The machine learning integration tool of claim 1, wherein the one or more processors are configured to execute the computer-readable instructions to transform the non-automated feedback by pre-processing and validating the non-automated feedback.

7. The machine learning integration tool of claim 1, wherein the one or more processors are configured to execute the computer-readable instructions to analyze effectiveness of the non-automated feedback based on metadata collected in association with the non-automated feedback.

8. One or more non-transitory computer-readable media comprising computer-readable instructions, which when executed by one or more processors of a machine learning orchestration system, cause the machine learning orchestration system to:
execute a workflow associated with a machine learning process;
determine, during execution of the machine learning process, that non-automated feedback is required;
generate a virtual input unit for receiving the non-automated feedback;
modify raw data used for the machine learning process with the non-automated feedback to yield updated data; and
complete the machine learning process using the updated data.

9. The one or more non-transitory computer-readable media of claim 8, wherein the execution of the computer-readable media by one or more processors further cause the machine learning orchestration system to determine that the non-automated feedback is required when an output of the machine learning process does not meet a threshold.

10. The one or more non-transitory computer-readable media of claim 9, wherein the threshold is one of an accuracy threshold and a confidence threshold.

11. The one or more non-transitory computer-readable media of claim 8, wherein the virtual input unit is one a text message, an electronic mail message or an online advertisement.

12. The one or more non-transitory computer-readable media of claim 8, wherein the execution of the computer-readable media by one or more processors further cause the machine learning orchestration system to determine that the non-automated feedback is required during one or more of a training data generation phase of the machine learning process, a model tuning phase of the machine learning process, and a model validation phase of the machine learning process.

13. The one or more non-transitory computer-readable media of claim 8, wherein the execution of the computer-readable media by one or more processors further cause the machine learning orchestration system to transform the non-automated feedback by pre-processing and validating the non-automated feedback.

14. The one or more non-transitory computer-readable media of claim 8, wherein the execution of the computer-readable media by one or more processors further cause the machine learning orchestration system to analyze effectiveness of the non-automated feedback based on metadata collected in association with the non-automated feedback.

15. A machine learning method comprising:
executing a workflow associated with a machine learning process;
determining, during execution of the machine learning process, that non-automated feedback is required;
generating a virtual input unit for receiving the non-automated feedback;
modifying raw data used for the machine learning process with the non-automated feedback to yield updated data; and
completing the machine learning process using the updated data.

16. The method of claim 15, wherein the non-automated feedback is required when an output of the machine learning process does not meet a threshold.

17. The method of claim 16, wherein the threshold is one of an accuracy threshold and a confidence threshold.

18. The method of claim 15, wherein the virtual input unit is one a text message, an electronic mail message or an online advertisement.

19. The method of claim 15, wherein the non-automated feedback is required during one or more of a training data generation phase of the machine learning process, a model tuning phase of the machine learning process, and a model validation phase of the machine learning process.

20. The method of claim 16, further comprising:
analyzing effectiveness of the non-automated feedback based on metadata collected in association with the non-automated feedback.
